(19) United States
(12) Patent Application Publication
(10) Pub. No.: US 2008/0303832 A1
(43) Pub. Date: Dec. 11, 2008

(54) METHOD OF GENERATING TWO-DIMENSIONAL/THREE-DIMENSIONAL CONVERTIBLE STEREOSCOPIC IMAGE BITSTREAM AND METHOD AND APPARATUS FOR DISPLAYING THE SAME

(75) Inventors: Jae-seung KIM, Yongin-si (KR); Yong-tae KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/950,834

(22) Filed: Dec. 5, 2007

Related U.S. Application Data
(60) Provisional application No. 60/943,127, filed on Jun. 11, 2007.

(30) Foreign Application Priority Data
Jul. 27, 2007 (KR) 10-2007-0075873

(51) Int. Cl. G09G 5/00; G06F 15/00

(52) U.S. Cl. 345/501; 345/7

(57) ABSTRACT

Provided is a method of generating a two-dimensional (2D)/three-dimensional (3D) convertible stereoscopic image bitstream. The method includes receiving 3D image data; storing predetermined display mode information in a header region of a stereoscopic image bitstream in order to determine whether to display the 3D image data in a 2D display mode or a 3D display mode; and storing the 3D image data in a payload region of the stereoscopic image bitstream.

### CROSS-REFERENCE TO RELATED PATENT APPLICATIONS

This application claims priority from Korean Patent Application No. 10-2007-0075873, filed on Jul. 27, 2007 in the Korean Intellectual Property Office, and the benefit of U.S. Provisional Patent Application No. 60/943,127, filed on Jun. 11, 2007, in the U.S. Patent and Trademark Office, the disclosures of which are incorporated herein in their entirety by reference.

### BACKGROUND OF THE INVENTION

1. Field of the Invention

Methods and apparatuses consistent with the present invention relate to generating a two-dimensional (2D)/three-dimensional (3D) convertible stereoscopic image bitstream and displaying the same, and more particularly, to generating a stereoscopic image bitstream whose display mode can be converted from a 3D display mode to a 2D display mode, and vice versa, at a request of a user and displaying the stereoscopic image bitstream.

2. Description of the Related Art

Recently, research into technologies for broadcasting three-dimensional (3D) images on digital televisions has been conducted. In digital broadcasting, analog video, audio and data signals are converted into digital signals, and the digital signals are compressed and transmitted accordingly. When the digital signals are received, they are converted back into the original video, audio and data signals and reproduced accordingly. Digital broadcasting offers higher image quality than conventional analog broadcasting.

FIG. 1A illustrates the structure of an International Organization for Standardization (ISO)-based media bitstream.

Referring to FIG. 1A, “ftyp” indicates the type of an image file, and movie data (moov) includes video and audio tracks having information that is required to reproduce video data and audio data, respectively. Media data (labeled “movie data” in FIG. 1A) (mdat) includes video and audio stream data.

FIG. 1B illustrates an example of a data stream based on an ISO-based media bitstream.

An ISO-based data stream illustrated in FIG. 1B includes ftyp, moov and mdat arranged sequentially. Video track data and audio track data are recorded side by side in mdat, and head information defining characteristics of each of the video track data and the audio track data is recorded in moov. In addition, since a plurality of video and audio tracks can be recorded, header information is provided for each track.

Research is also being conducted on a method and apparatus for displaying received 3D images using digital broadcasting technology. Generally, the binocular parallax of viewers is utilized to display 3D images. Conventional methods of displaying 3D images using binocular parallax include a stereoscopic method and an autostereoscopic method. In the stereoscopic method, a viewer has to wear glasses, such as polarization glasses and liquid crystal (LC) shutter glasses, in order to see 3D images. In the autostereoscopic method, a viewer can see 3D images with the naked eye by using a device having a lenticular lens.

The stereoscopic method which displays 3D images using a polarization projector is applied mostly in public places, such as movie theaters. On the other hand, the autostereoscopic method is applied to, for example, displays for games, home televisions (TVs) and displays for exhibitions, which are used by an individual or a number of individuals.

Most 3D image displays that have been introduced so far can display only 3D images. However, since 3D contents are not yet produced sufficiently, consumers may not be convinced to buy 3D image displays. Accordingly, a lot of research is being conducted to develop a 2D/3D convertible display method and apparatus which can selectively display 2D or 3D images.

Selective display of 2D or 3D images is required in most fields including digital broadcast systems, simulations and medical analysis. In addition, since binocular parallax of viewers is used to display 3D images, the viewers may feel eye fatigue after watching the 3D images for a long time. In this regard, a 2D/3D convertible display method and apparatus which can selectively display 2D or 3D images are being researched.

### SUMMARY OF THE INVENTION

Exemplary embodiments of the present invention provide an image bitstream including header information required to determine whether to display stereoscopic image data in a 2D or 3D display mode and a method of generating the image bitstream.

Exemplary embodiments also provide a method and apparatus for displaying a stereoscopic image bitstream whose display mode can be converted from a 3D display mode to a 2D display mode, and vice versa, at a request of a user.

According to an aspect of the present invention, there is provided a method of generating a stereoscopic image bitstream. The method includes receiving 3D image data; storing predetermined display mode information in a header region of the stereoscopic image bitstream in order to determine whether to display the 3D image data in a 2D display mode or a 3D display mode; and storing the 3D image data in a payload region of the stereoscopic image bitstream.

The display mode information may include one bit which indicates the 2D display mode or the 3D display mode.

Zero may be set as an initial value of the display mode information so that the 3D image data can be displayed in the 3D display mode.

When the stereoscopic image bitstream is based on an International Standardization Organization (ISO) format, header data may include header information of at least one of a video track and an audio track and include the display mode information placed after the header information of the video track.

According to another aspect of the present invention, there is provided a method of displaying a stereoscopic image bitstream. The method includes analyzing header information of input 3D image data and extracting display mode information indicating whether 3D image data of the input 3D image data is to be displayed in a 2D display mode or a 3D display mode; generating 2D display information using a conversion signal, which is input for display mode conversion, and the extracted display mode information; and determining a display mode of the 3D image data based on the 2D display information and displaying the 3D image data in the determined display mode.

The method may further include generating the conversion signal in response to a mode conversion request of a user from the 2D display mode to the 3D display mode, and vice versa.

The 2D display information may be generated by adding the conversion signal to the display mode information.

The 2D display information may be represented by a binary value of zero or one.

If the conversion signal is input, a value of the conversion signal may be one.

The 3D image data may be displayed in the 3D display mode if a value of the 2D display information is zero and may be displayed in the 2D display mode if the value of the 2D display information is one.

If the 3D image data is to be displayed in the 3D display mode, the 3D image data may be generated as a 3D image and displayed accordingly on a display screen.

If the 3D image data is to be displayed in the 2D display mode, the 3D image data may be converted into a 2D image and displayed accordingly on the display screen.

If the 3D image data is composed of multi-view image data, data of one viewpoint may be displayed.

According to another aspect of the present invention, there is provided an apparatus for displaying a stereoscopic image bitstream. The apparatus includes a display mode information extraction unit analyzing header data of input 3D image data and extracting display mode information indicating whether 3D image data of the input 3D image data is to be displayed in a 2D display mode or a 3D display mode; a 2D display information generation unit generating 2D display information using a conversion signal, which is input for display mode conversion, and the extracted display mode information; and a display unit determining a display mode of the 3D image data based on the 2D display information and displaying the 3D image data in the determined display mode.

The apparatus may further include a conversion signal input unit receiving the conversion signal in response to a mode conversion request from the 2D display mode to the 3D display mode, and vice versa.

According to another aspect of the present invention, there is provided a computer-readable recording medium on which a program for executing a method of generating a stereoscopic image bitstream is recorded.

According to another aspect of the present invention, there is provided a computer-readable recording medium on which a program for executing a method of displaying a stereoscopic image bitstream is recorded.

According to another aspect of the present invention, there is provided a stereoscopic image bitstream structure including a header region comprising 2D display information required to determine whether to display 3D image data in a 2D display mode or a 3D display mode; and a payload region recording the 3D image data whose display mode is determined based on the 2D display information.

### BRIEF DESCRIPTION OF THE DRAWINGS

The above and other exemplary aspects and advantages of the present invention will become more apparent by the following detailed description of exemplary embodiments thereof with reference to the attached drawings in which:

FIG. 1A illustrates the structure of an International Organization for Standardization (ISO)-based media bitstream;

FIG. 1B illustrates an example of a data stream based on an ISO-based media bitstream;

FIG. 2A illustrates a 2D/3D convertible stereoscopic image bitstream according to an exemplary embodiment of the present invention;

FIG. 2B illustrates a stereoscopic image bitstream compatible with an ISO-based file format according to an exemplary embodiment of the present invention;

FIG. 3 is a block diagram of an apparatus for displaying a 2D/3D convertible stereoscopic image bitstream according to an exemplary embodiment of the present invention;

FIG. 4 illustrates a 2D display information generation function according to an exemplary embodiment of the present invention;

FIG. 5 is a flowchart illustrating the operation of a display unit included in the apparatus of FIG. 3;

FIG. 6 illustrates a display image generation method used by the display unit of the apparatus of FIG. 3 according to an exemplary embodiment of the present invention;

FIG. 7 is a flowchart illustrating a method of generating a 2D/3D convertible stereoscopic image bitstream according to an exemplary embodiment of the present invention; and

FIG. 8 is a flowchart illustrating a method of displaying a 2D/3D convertible stereoscopic image bitstream according to an exemplary embodiment of the present invention.

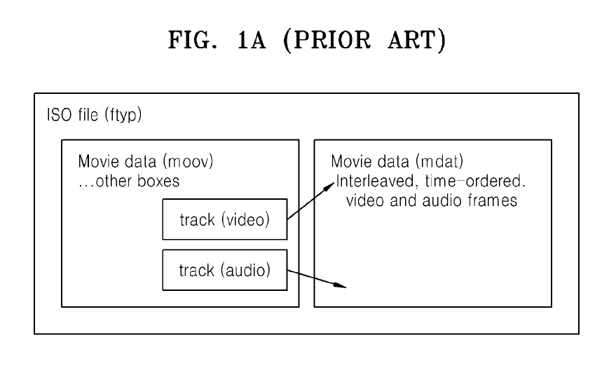

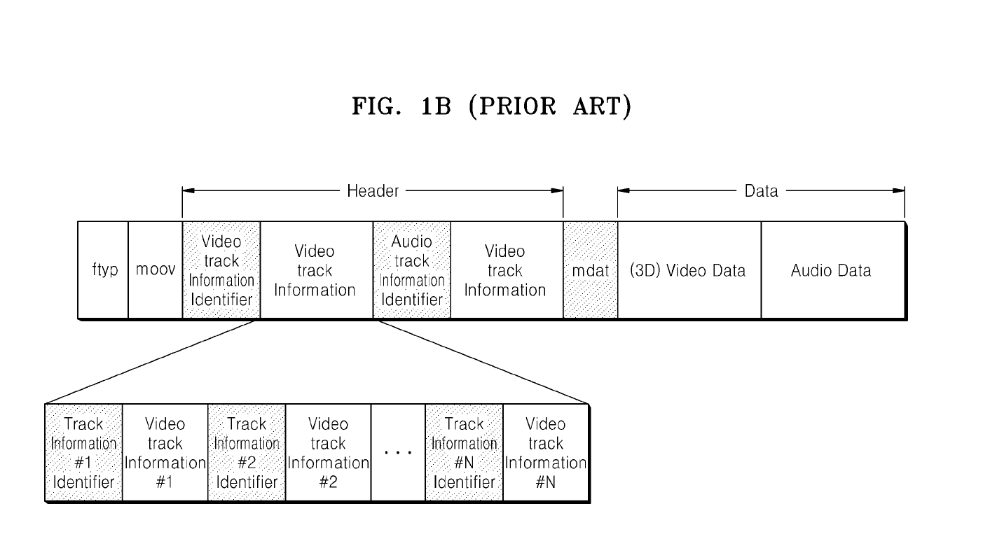

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those of ordinary skill in the art.

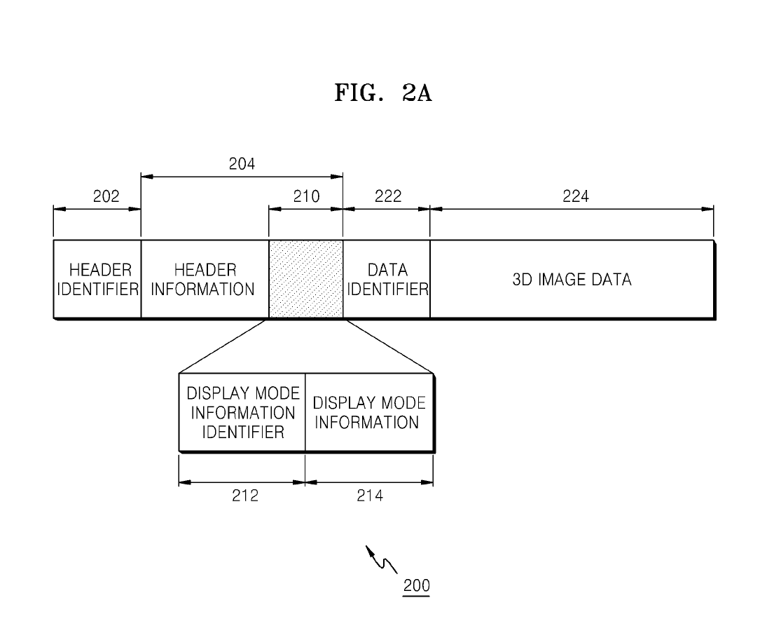

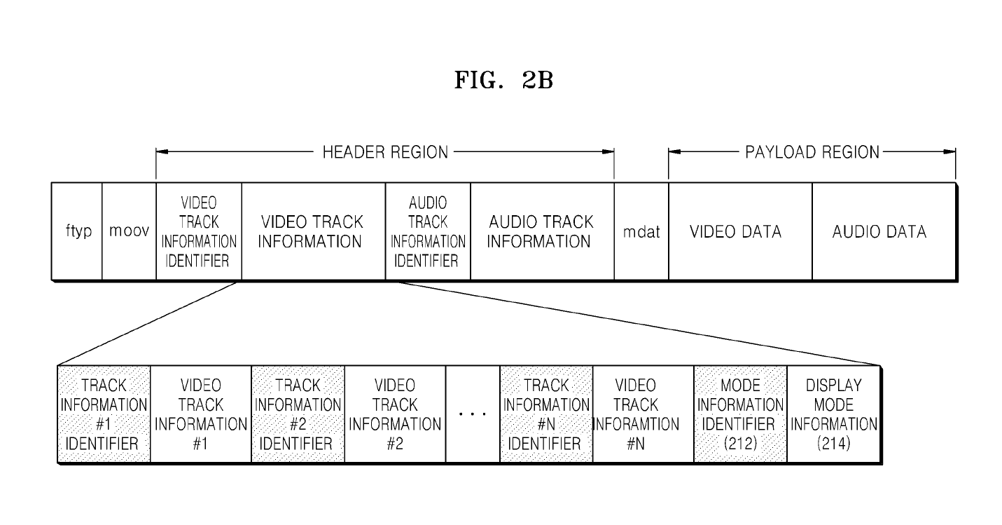

A stereoscopic image bitstream, a method of generating the same, and a method and apparatus for displaying the same according to an exemplary embodiment of the present invention will now be described with reference to FIGS. 2A through 8.

FIG. 2A illustrates a two-dimensional (2D)/three-dimensional (3D) convertible stereoscopic image bitstream 200 according to an embodiment of the present invention.

Referring to FIG. 2A, the stereoscopic image bitstream 200 includes a header identifier 202, header information 204, a data identifier 222, and 3D image data 224. The header information 204 includes display mode header information 210 of the 3D image data 224. The display mode header information 210 includes a display mode information identifier 212 and display mode information 214.

The header identifier 202 has a predetermined value by which the header information 204 stored in a header region of the stereoscopic image bitstream 200 can be identified.

The header information 204 includes header information regarding various characteristics of the 3D image data 224. For example, the header information 204 may include information regarding the bitrate, sampling frequency, compression standardization, and channel mode of the 3D image data 224. The header information 204 includes the display mode header information 210 of the 3D image data 224 and headers for other various characteristics of the 3D image data 224. Characteristics of the display mode header information 210 according to an embodiment of the present invention will be described in detail later.

The data identifier 222 is used to identify the 3D image data 224 stored in a payload region of the stereoscopic image bitstream 200 and has a predetermined value indicating characteristics of the 3D image data 224.

The 3D image data 224 includes video data or audio data defined in the header information 204.

In an embodiment of the present invention, the 3D image data 224 includes multi-view 2D image data. For example, left and right images may be separately stored in the payload region.

In another embodiment of the present invention, the 3D image data 224 is multi-view 2D image data that is composed of 3D image data. For example, the 3D image data 224 may include a combination of left video data and right video data.

The display mode header information 210 is included in the header information 204 and defines a 2D or 3D display mode of the 3D image data 224. The display mode header information 210 includes the display mode header identifier 212, which is used to identify the display mode information 214, and the display mode information 214 which defines a display mode of the 3D image data 224.

The display mode information 214 records information regarding whether the 3D image data 224 is to be displayed in the 3D or 2D display mode. In an embodiment of the present invention, if a value of the display mode information 214 is zero, it indicates the 3D display mode. If the value of the display mode information 214 is one, it indicates the 2D display mode. In this embodiment, zero is set as a default value of the display mode information 214.

FIG. 2B illustrates a stereoscopic image bitstream compatible with an ISO-based file format according to an embodiment of the present invention.

In the ISO-based stereoscopic image bitstream of the present embodiment, 2D display information of video data is placed after a plurality of pieces of video track information of header data. Referring to FIG. 2A, a mode information identifier 212 and display mode information 214 are placed after a plurality of track information identifiers and a plurality of pieces of video track information.

Therefore, whether to display 3D video data, which is stored in a payload region of mdata (i.e., media data,) in its original 3D display mode or a 2D display mode is determined based on the 2D display information. In an embodiment of the present invention, the display mode information 214 may be defined for each video track. In another embodiment of the present invention, the display mode information 214 may be defined for all video tracks included in the corresponding stereoscopic image bitstream.

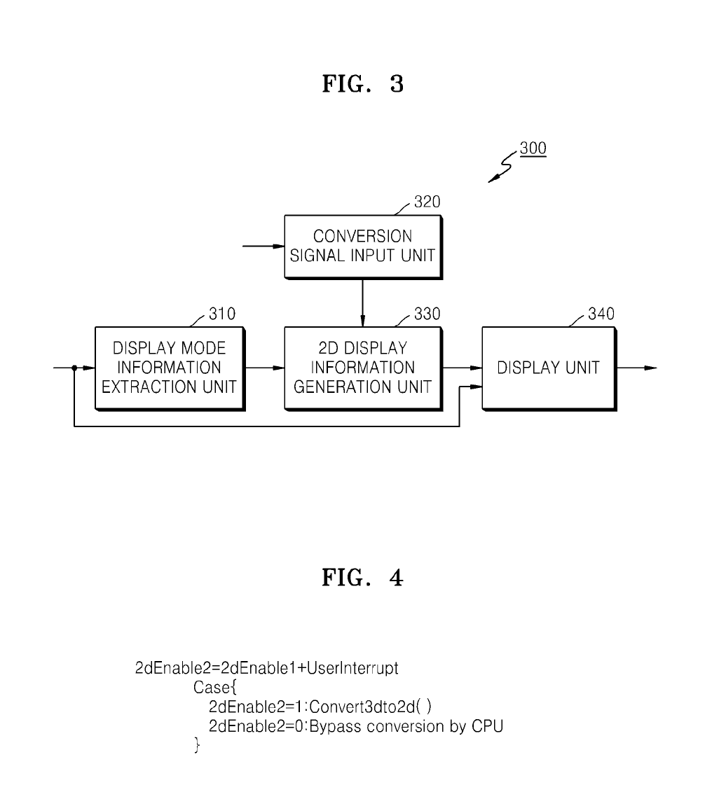

Hereinafter, an apparatus and method for displaying a stereoscopic image bitstream, which can display stereoscopic image data in a 3D or 2D display mode by using a stereoscopic image bitstream as the one described above, will be described in detail with reference to FIGS. 3 through 6.

FIG. 3 is a block diagram of an apparatus 300 for displaying a 2D/3D convertible stereoscopic image bitstream according to an exemplary embodiment of the present invention.

Referring to FIG. 3, the apparatus 300 includes a display mode information extraction unit 310, a conversion signal input unit 320, a 2D display information generation unit 330, and a display unit 340.

The display mode information extraction unit 310 receives 3D image data, analyses header information of the received 3D image data, extracts display mode information indicating whether the 3D image data is to be displayed in a 2D or 3D display mode, and outputs the extracted display mode information to the 2D display information generation unit 330.

The display mode information extraction unit 310 according to the present invention receives image data which is structured like the 2D/3D convertible stereoscopic image bitstream 200 of FIG. 2A described above. In addition, the display mode information extracted by the display mode information extraction unit 310 according to the present embodiment is the display mode information 214 (see FIG. 2A) extracted from the 2D/3D convertible stereoscopic image bitstream 200. The display mode information extraction unit 310 interprets the header information 204 (see FIG. 2A) of the header region, identifies the display mode information (214) by the display mode information identifier 212 (see FIG. 2A), and extracts the display mode information 214.

The conversion signal input unit 320 receives a conversion signal in order to convert the 2D display mode to the 3D display mode, and vice versa, and outputs the received conversion signal to the 2D display information generation unit 330. The conversion signal is defined to convert a display mode of 3D image data from the 3D display mode to the 2D display mode or from the 2D display mode to the 3D display mode.

Although a control unit of the apparatus 300 is not illustrated in FIG. 3, when a conversion from the 2D display mode to the 3D display mode, and vice versa, is required, the control unit may set the conversion signal accordingly.

In addition, in the present embodiment, when a user issues a predetermined input command for changing a display mode in order to view a stereoscopic image in the 2D mode while viewing the stereoscopic image in the 3D display mode, the conversion signal is generated. Likewise, the conversion signal is used to change the display mode the other way around.

In the present embodiment, if the conversion signal is generated, it always has a value of one by a central processing unit (CPU) (not shown) or a microcomputer (not shown) of the apparatus 300.

The 2D display information generation unit 330 receives the display mode information 214 from the display mode information extraction unit 310 and the conversion signal from the conversion signal input unit 320. Then, the 2D display information generation unit 330 generates 2D display information using the conversion signal and the display mode information 214 and outputs them to the display unit 340. A function and method for generating 2D display information will be described in detail later.

The display unit 340 determines a display mode based on the input image data and the 2D display information received from the 2D display information generation unit 330 and displays the 3D image data in the determined display mode. In the present embodiment, since input image data is 3D image data, the display unit 340 displays the 3D image data 224 basically in the 3D display mode. However, the display mode of the 3D image data 224 can be converted based on the interpretation of the 2D display information. A process of converting a display mode will be described in detail later.

FIG. 4 illustrates a 2D display information generation function and a display mode conversion function according to an exemplary embodiment of the present invention. The 2D display information generation function illustrated in FIG. 4 is related to roles of the 2D display information generation unit 330 and the display unit 340.

‘2dEnable1’ indicates the display mode information 214 of the present invention, and ‘UserInterrupt’ indicates a conversion signal input by a user. In addition, ‘Convert3dto2d( )’ indicates a function for commanding the conversion of the display mode of the 3D image data 224 from the 3D display mode to the 2D display mode. ‘Bypass conversion by CPU’ indicates a command for terminating a functional operation without converting a display mode as instructed by a CPU.

Referring to FIG. 4, the 2D display information generation unit 330 generates 2D display information (2dEnable2) by adding the conversion signal (UserInterrupt) to the display mode information 214 (2dEnable1). Since each of the 2D display information and the display mode information 214 is a binary number having a value of zero or one, if the conversion signal (UserInterrupt) is input according to an embodiment of the present invention, the conversion signal (UserInterrupt), which always has a value of one, may be added to the display mode information 214 (2dEnable1). Accordingly, the 2D display information may have a reciprocal value which is always opposite to that of the display mode information 214.

That is, if the display mode information 214 has a value of zero, a value of the 2D display information becomes one in response to the conversion signal. If the display mode information 214 has a value of one, the value of the 2D display information becomes zero in response to the conversion signal. If no conversion request is made, since the conversion signal has a value of zero, the 2D display information and the display mode information 214 may have equal values.

If zero is set as an initial value of the display mode information 214 as described above and if no conversion request is made, since the conversion signal has a value of zero, the 2D display information also has a value of zero.

The display unit 340 determines the display mode of the 3D image data 224 based on the 2D display information received from the 2D display information generation unit 330. If the value of the 2D display information is one, it indicates that the conversion signal has been input. Therefore, the display mode of the 3D image data 224 must be converted from the 3D display mode, which is a default display mode, to the 2D display mode. Accordingly, the display unit 340 converts the 3D display mode to the 2D display mode using the function ‘Convert3dto2d( )’ illustrated in FIG. 4.

If the value of the 2D display information received from the 2D display information generation unit 330 is zero, it indicates that no conversion signal has been input since it has had a default value. Therefore, there is no need for the display unit 340 to convert the display mode of the 3D image data 224. That is, if the value of the 2D display information is zero, the display unit 340 receives the command ‘Bypass conversion by CPU’ from the CPU of the apparatus 300 and displays the 3D image data 224 in the 3D display mode without mode conversion.

Although not shown in the drawings, if the value of the display mode information 214 is zero, the value of the 2D display information becomes zero in response to the conversion signal. Therefore, the display unit 340 has to convert the display mode of the 3D image data 224 to the 3D display mode. If no conversion request is made, since the value of the conversion signal is zero, the display mode of the 3D image data 224 continues to be the 2D display mode.

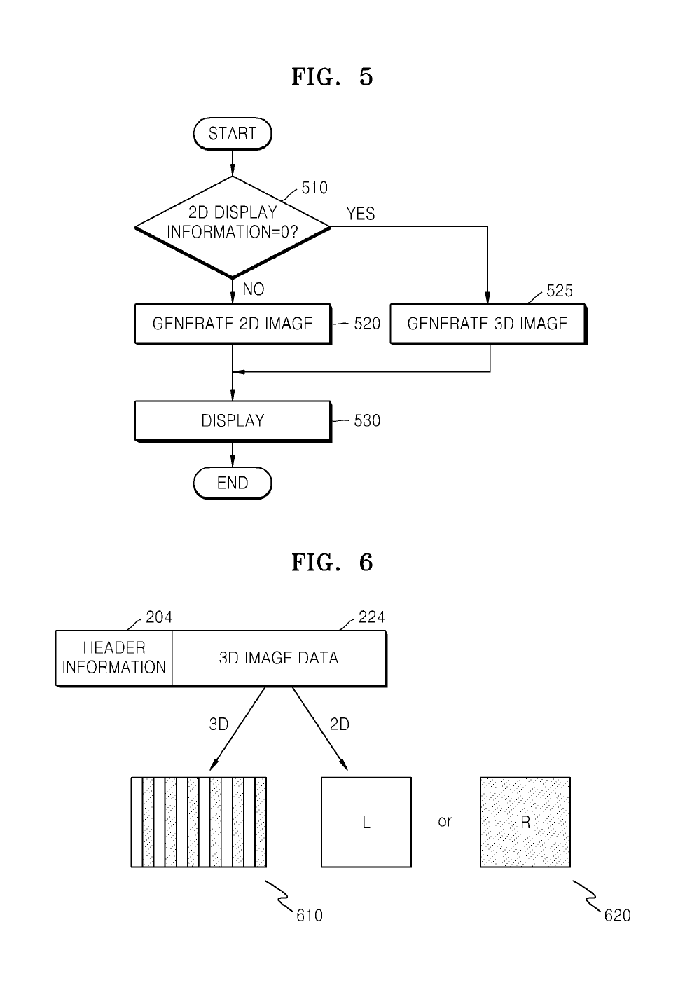

FIG. 5 is a flowchart illustrating the operation of the display unit 340 included in the apparatus 300 of FIG. 3. Functions of the display unit 340 of the apparatus 300 will now be described in detail with reference to FIG. 5.

Referring to FIG. 5, in operation 510, a display mode is selected based on a value of 2D display information received from the 2D display information generation unit 330. If a value of the 2D display information is one, operation 520 is performed. If the value of the 2D display information is zero, operation 525 is performed.

In operation 520, since the value of the 2D display information is one, the input 3D image data 224 is converted into a 2D image so that the 3D image data can be displayed in the 2D display mode. A method of generating a 2D image will be described later.

In operation 525, since the value of the 2D display information is zero, the 3D image data 224 is generated as a 3D image so that the 3D image data 224 can be displayed in the 3D display mode. A method of generating a 3D image will be described later.

In operation 530, an image generated in operation 520 or 525 is displayed. That is, the 2D image generated in operation S520 is displayed in the 2D display mode, or the 3D image generated in operation 525 is displayed in the 3D display mode.

FIG. 6 illustrates a display image generation method used by the display unit 340 of the apparatus 300 of FIG. 3 according to an exemplary embodiment of the present invention.

FIG. 6 describes functions of the display unit 340 of the apparatus 300 in detail and further describes operations 520 and 525 of FIG. 5.

Referring to FIG. 6, an image 610 is a 3D image composed of images at two viewpoints. The 3D image is generated in order to display the 3D image data 224 in the 3D display mode. The images at two viewpoints may include a left image and a right image. In the present embodiment, odd-numbered columns of the image 610 correspond to those of the left image, and even-numbered columns of the image 610 correspond to those of the right image.

An image 620 is a 2D image into which the 3D image data 224 has been converted so that the 3D image data 224 can be displayed in the 2D display mode. In the present embodiment, any one of the left image and the right image can be adopted as an image to be displayed in the 2D display mode for converting the 3D image data 224 into a 2D image. Although the left image or the right image was obtained from one viewpoint, it is a complete image, albeit having parallax. Therefore, the 2D image can be displayed.

A 3D image may be formed using 2D images at different viewpoints or 3D image data may be converted into a 2D image using various methods that those of ordinary skill in the art to which the present invention pertains can implement.

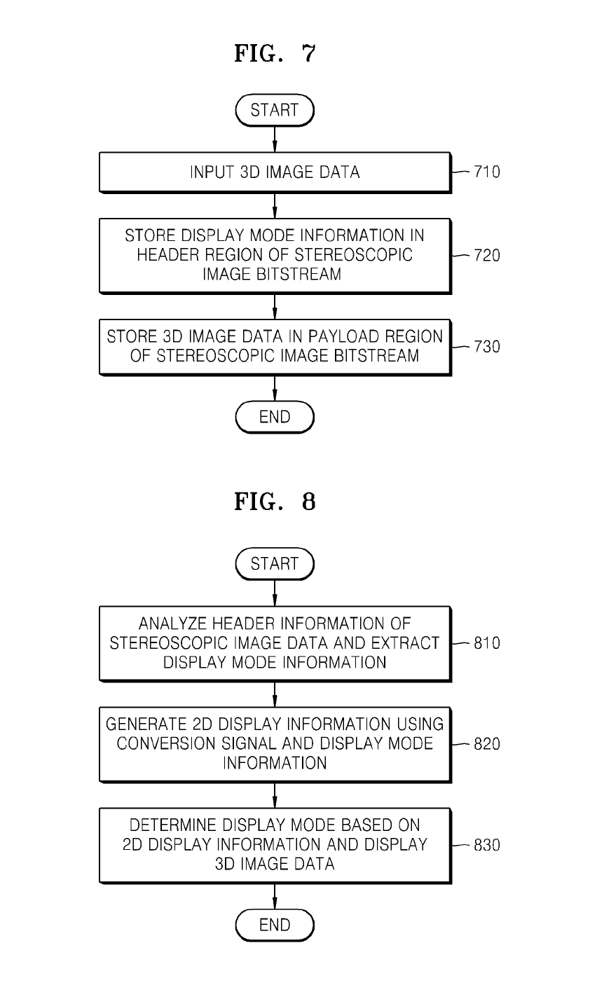

FIG. 7 is a flowchart illustrating a method of generating a 2D/3D convertible stereoscopic image bitstream according to an exemplary embodiment of the present invention.

Referring to FIG. 7, 3D image data is input in operation 710.

In operation 720, predetermined display mode information is stored in a header region of a stereoscopic image bitstream. In this case, the display mode information is required to determine whether to display the 3D image data in the 2D display mode or the 3D display mode.

In operation 720, the 3D image data is stored in a payload region of the stereoscopic image bitstream.

FIG. 8 is a flowchart illustrating a method of displaying a 2D/3D convertible stereoscopic image bitstream according to an exemplary embodiment of the present invention.

Referring to FIG. 8, in operation 810, header information of input 3D image data is analyzed, and display mode information is extracted based on the analyzed header information. In this case, the display mode information indicates whether 3D image data of the input 3D image data is to be displayed in the 2D display mode or the 3D display mode. In the present embodiment, since the display mode information is a binary number, it has a value of zero or one. In addition, zero is set as a default value of the display mode information.

In operation 820, 2D display information is generated by using a conversion signal, which is input for mode conversion, and the extracted display mode information.

The conversion signal may be controlled according to a display environment of a display device. The conversion signal may be input at a request of a user. A 2D display signal is generated by adding the conversion signal to the display mode information extracted in operation 810. The conversion signal according to the present invention always has a value of one when there is a mode conversion request. Therefore, since the 2D display information is a binary number, if the conversion signal is input, it always becomes a reciprocal number.

In operation 830, a display mode of the input 3D image data is determined based on the 2D display information, and the 3D image data is displayed in the determined display mode.

If a value of the 2D display information is zero, the 3D image data is displayed in the 3D display mode. Conversely, if the value of the 2D display information is one, the 3D image data is displayed in the 2D display mode. If a conversion request is input, since the value of the conversion signal becomes one, the value of the 2D display information becomes a reciprocal value of the value of the display mode information. Accordingly, the display mode of the 3D image data is changed to an opposite mode.

In a method of generating a 2D/3D convertible stereoscopic image bitstream according to the present invention, a display mode of 3D image data can be converted from a 2D display mode to a 3D display mode, and vice versa, as instructed by a display device or at a request of a user.

After listening to and viewing 3D image data for a long time, a user may feel eye fatigue. In addition, if a communication environment is poor, 3D images including a large volume of data cannot be smoothly transmitted, thereby making it difficult to enjoy the 3D images. In order to address these problems, a method and apparatus for displaying a 2D/3D convertible stereoscopic image bitstream according to the present invention can selectively display a stereoscopic image in the 2D display mode or the 3D display mode at a request of a user or according to a communication environment.

The present invention can be applied to international standardization of a stereoscopic image file format.

A stereoscopic image bitstream and a method and apparatus for displaying the same have been described above in relation to images for ease of description. However, it will be understood by those of ordinary skill in the art that the present invention can be applied not only to stereoscopic images but also stereoscopic audio data. Hence, features of the present invention should not be construed as being limited to images.

The embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), and optical recording media (e.g., CD-ROMs, or DVDs).

While the present invention has been particularly shown and described with reference to exemplary embodiments thereof, it will be understood by those of ordinary skill in the art that various changes in form and details may be made therein without departing from the spirit and scope of the present invention as defined by the following claims. The embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of generating a stereoscopic image bitstream, the method comprising:
receiving three-dimensional (3D) image data;
storing predetermined display mode information in a header region of the stereoscopic image bitstream, wherein the display mode information indicates whether to display the 3D image data in a two-dimensional (2D) display mode or a 3D display mode; and
storing the 3D image data in a payload region of the stereoscopic image bitstream.

2. The method of claim 1, wherein the display mode information comprises one bit.

3. The method of claim 2, wherein an initial value of the display mode information indicates that the 3D image data is to be displayed in the 3D display mode.

4. The method of claim 1, wherein, the stereoscopic image bitstream satisfies an International Standardization Organization (ISO) base media file format, the header region comprises header information of at least one of a video track and an audio track and the display mode information placed in the header information of the video track.

5 . A method of displaying a stereoscopic image bitstream, the method comprising:
analyzing header information of input three-dimensional (3D) image data and extracting display mode information indicating whether 3D image data of the input 3D image data is to be displayed in a two-dimensional (2D) display mode or a 3D display mode;
generating 2D display information using a conversion signal, which is input for display mode conversion, and the extracted display mode information; and
determining a display mode of the 3D image data based on the 2D display information and displaying the 3D image data in the determined display mode.

6. The method of claim 5, further comprising generating the conversion signal in response to a mode conversion request of a user from the 2D display mode to the 3D display mode, or vice versa.

7. The method of claim 6, wherein the 2D display information is generated by adding the conversion signal to the display mode information.

8. The method of claim 5, wherein the 2D display information is represented by a binary value of zero or one.

9. The method of claim 5, wherein, if the conversion signal is input, a value of the conversion signal is one.

10. The method of claim 5, further comprising displaying the 3D image data in the 3D display mode if a value of the 2D display information is zero and displaying the 3D image data in the 2D display mode if the value of the 2D display information is one.

11. The method of claim 5, further comprising, if the 3D image data is to be displayed in the 3D display mode, generating the 3D image data as a 3D image and displaying the 3D image accordingly on a display screen.

12. The method of claim 5, further comprising, if the 3D image data is to be displayed in the 2D display mode, converting the 3D image data into a 2D image and displaying the 2D image accordingly on the display screen.

13. The method of claim 12, further comprising, if the 3D image data is comprised of multi-view image data, displaying data of only one viewpoint.

14. An apparatus for displaying a stereoscopic image bitstream, the apparatus comprising:
a display mode information extraction unit which analyzes header data of input three-dimensional (3D) image data and extracts display mode information indicating whether 3D image data of the input 3D image data is to be displayed in a two-dimensional (2D) display mode or a 3D display mode;
a 2D display information generation unit which generates 2D display information using a conversion signal, which is input for display mode conversion, and the extracted display mode information; and
a display unit which determines a display mode of the 3D image data based on the 2D display information and displays the 3D image data in the determined display mode.

15. The apparatus of claim 14, further comprising a conversion signal input unit which receives the conversion signal in response to a mode conversion request from the 2D display mode to the 3D display mode.

16. The apparatus of claim 15, wherein the 2D display information generation unit generates the 2D display information by adding the conversion signal to the display mode information.

17. The apparatus of claim 14, wherein the 2D display information is represented by a binary value of zero or one.

18. The apparatus of claim 14, wherein, if the conversion signal is input, a value of the conversion signal is one.

19. The apparatus of claim 14, wherein the display unit displays the 3D image data in the 3D display mode if a value of the 2D display information is zero and displays the 3D image data in the 2D display mode if the value of the 2D display information is one.

20. The apparatus of claim 14, wherein, if the 3D image data is to be displayed in the 3D display mode, the display unit generates the 3D image data as a 3D image and displays the 3D image on a display screen.

21. The apparatus of claim 14, wherein, if the 3D image data is to be displayed in the 2D display mode, the display unit converts the 3D image data into a 2D image and displays the 2D image on the display screen.

22. The apparatus of claim 21, wherein, if the 3D image data is comprised of multi-view image data, the display unit displays data of one viewpoint.

23. A computer-readable recording medium on which a program for executing the method of claim 1 is recorded.

24. A computer-readable recording medium on which a program for executing the method of claim 5 is recorded.
